(19) United States
(12) Patent Application Publication
(10) Pub. No.: US 2009/0083006 A1
(43) Pub. Date: Mar. 26, 2009

(54) METHODS AND APPARATUS FOR THREE-DIMENSIONAL INVERSION OF ELECTROMAGNETIC DATA

(76) Inventor: Randall Mackie, San Francisco, CA (US)

Correspondence Address: Jeffrey E. Griffin, 10001 Richmond Avenue, Houston, TX, 77042, US

(21) Appl. No.: 12/197,239

(22) Filed: Aug. 23, 2008

Related U.S. Application Data
(60) Provisional application No. 60/973,885, filed on Sep. 20, 2007.

(51) Int. Cl. G06F 17/50

(52) U.S. Cl. 703/1

(57) ABSTRACT

Methods and systems in accordance with this invention perform three-dimensional inversion of electromagnetic data, such as magnetotelluric (“MT”) data and controlled-source electromagnetic (“CSEM”) data, and three-dimensional joint inversion of MT and CSEM data. In exemplary embodiments, nonlinear conjugate gradient (“NLCG”) methods are used in lieu of iterative, linearized inversion, and line-search and preconditioning techniques are used that accommodate and exploit the structure of the MCSEM and MT problem.

### REFERENCE TO RELATED APPLICATIONS

This application claims the benefit of U.S. Provisional Patent Application Ser. No. 60/973,885, filed 20 Sep. 2007, which is incorporated by reference herein in its entirety.

### BACKGROUND

The invention pertains to three-dimensional inversion of electromagnetic data. In particular, this invention pertains to methods and apparatus for three-dimensional (“3-D”) inversion of magnetotelluric and/or controlled source electromagnetic data. More particularly, this invention pertains to methods and apparatus for 3-D joint inversion of marine magnetotelluric and marine controlled source electromagnetic data for subsea exploration and hydrocarbon resource evaluation.

For many years, various techniques have been used to identify and monitor hydrocarbon reserves (e.g., petroleum and natural gas) located beneath the earth, both on land and underwater. For example, FIG. 1 illustrates a simplified cross-sectional view of a portion of the earth located below a body of water 10, such as an ocean. Beneath the ocean floor 12 there may be one or more layers of sediment 14, with an oil reservoir 16 buried deep within the sediment 14. The electrical resistivity r1 of sea water 10 is typically much less than the resistivity r2 of sediment 14, which in turn is typically much less than the resistivity r3 of oil reservoir 16. Thus, one way to distinguish between the various subsurface geophysical features involves measuring the electrical resistivity at numerous subsurface depths, and then using the measured data to create an “imag” of the subsurface features. In particular, a series of resistivity measurements are collected, and the measured data are then “inverted” to derive earth resistivity models that fit the measured data.

Numerous electrical and electromagnetic (“EM”) methods have been developed to measure subsurface electrical resistivity, which depends, for example, on lithological, pore fluid, temperature, and chemical variations. Such previously known EM methods include magnetotelluric (“MT”) and controlled source electromagnetic (“CSEM”) methods. MT methods have a long history of use in diverse applications including deep-Earth studies as well as mining, petroleum, and geothermal exploration. Likewise, CSEM methods have been used both onshore for shallow exploration targets as well as offshore in a marine environment. Indeed, marine magnetotellurics (“mMT”) and marine controlled source electromagnetics (“mCSEM”) are both used for subsea exploration and hydrocarbon resource evaluation. Although early uses of mCSEM were geared towards the study of oceanic lithosphere, more recently it has been used for hydrocarbon exploration.

FIG. 2 illustrates a previously known mCSEM surveying system 20 that includes transmitter 22 and one or more receivers 24. Transmitter 22 transmits an electromagnetic signal 26 (e.g., an electric current or magnetic field) into the earth below ocean floor 12, and a sensor in each receiver 24 measures a corresponding received signal (e.g., a voltage and/or magnetic field). The received signals are typically filtered, amplified, and converted to digital data that may be stored for subsequent data processing. In particular, the measured data may be inverted to generate a subsurface resistivity model that may be used to estimate resistivities at various locations (e.g., x₁ and x₂) in the vicinity of transmitter 22 and receivers 24.

Numerous inversion techniques have been developed for generating such subsurface resistivity models. In particular, nonlinear inverse problems typically have been implemented using iterative, linearized inversion. When run to convergence, such techniques minimize an objective function over the space of models and, in this sense, produce an optimal solution of the nonlinear inverse problem. Although such techniques may be readily used for generating one- and two-dimensional models, the general usefulness of iterative, linearized inversion algorithms is greatly limited in 3-D electromagnetic applications.

In particular, conventional iterative, linearized inversion algorithms require computing both the forward problem and the Jacobian (partial derivative matrix) of the forward problem and solving a nonsparse, linear system on the model space at each inversion iteration. For 3-D modeling, the solution of such problems can easily require millions of computationally intensive calculations, which are difficult to implement as a practical matter. Thus, it would be desirable to provide methods and apparatus that reduce the computational demands necessary to implement 3-D inversion of electromagnetic survey data.

Because MT fields are plane-wave in nature and horizontally uniform over large distances, MT data are largely insensitive to thin high resistivity layers that are associated with offshore hydrocarbon deposits trapped in thin planar sedimentary layers. However, because MT surveying techniques use naturally-occurring signals, such techniques may be used to image great depths in the earth (many tens or hundreds of kilometers) and are routinely used to image regional electrical resistivity structures. In contrast, CSEM data are quite sensitive to thin resistive layers because vertical electric currents from the electric dipole source fields respond dramatically to resistive layers. Consequently, CSEM is well suited for offshore hydrocarbon exploration.

Thus, MT and CSEM data provide complementary information: MT provides background regional resistivity structure, whereas CSEM responds to thin resistive targets. It therefore would be desirable to jointly invert CSEM and MT data to improve resolution of the resulting conductivity images. Further, it would be desirable to provide methods and apparatus that may be used to practically implement 3-D joint inversion of MT and CSEM survey data, such as mMT and mCSEM survey data.

### SUMMARY

Methods and systems in accordance with this invention perform 3D inversion that may be used for MT inversion, CSEM inversion, and joint MT/CSEM inversion. In one exemplary embodiment, nonlinear conjugate gradient methods are used in lieu of iterative, linearized inversion. As a result, exemplary methods and apparatus in accordance with this invention avoid the need to solve a linear system on the model space, replacing computation of the full Jacobian matrix with Jacobian operations, and embedding these features in the context of NLCG. By implementing NLCG with line-search and preconditioning techniques that accommodate and exploit the structure of the MCSEM and MT problem, the invented methods and systems provide a rapid and robust algorithm that is fully nonlinear and employs no approximation to the Jacobian.

### BRIEF DESCRIPTION OF THE DRAWINGS

Features of the present invention can be more clearly understood from the following detailed description considered in conjunction with the following drawings, in which the same reference numerals denote the same elements throughout, and in which:

FIG. 1 is a simplified cross-sectional view of a portion of Earth;

FIG. 2 is an exemplary previously known controlled source electromagnetic surveying system;

FIG. 3 is a block diagram of an exemplary 3-D inversion processing system in accordance with this invention;

FIG. 4 is a diagram of an exemplary 3-D inversion process in accordance with this invention;

FIG. 5 is a diagram of an exemplary forward calculation process in accordance with this invention;

FIG. 6 is a diagram of an exemplary 3-D inversion calculation process in accordance with this invention;

FIG. 7 is a diagram of an exemplary line search process in accordance with this invention; and

FIG. 8 is an exemplary system for performing 3-D inversion processing in accordance with this invention.

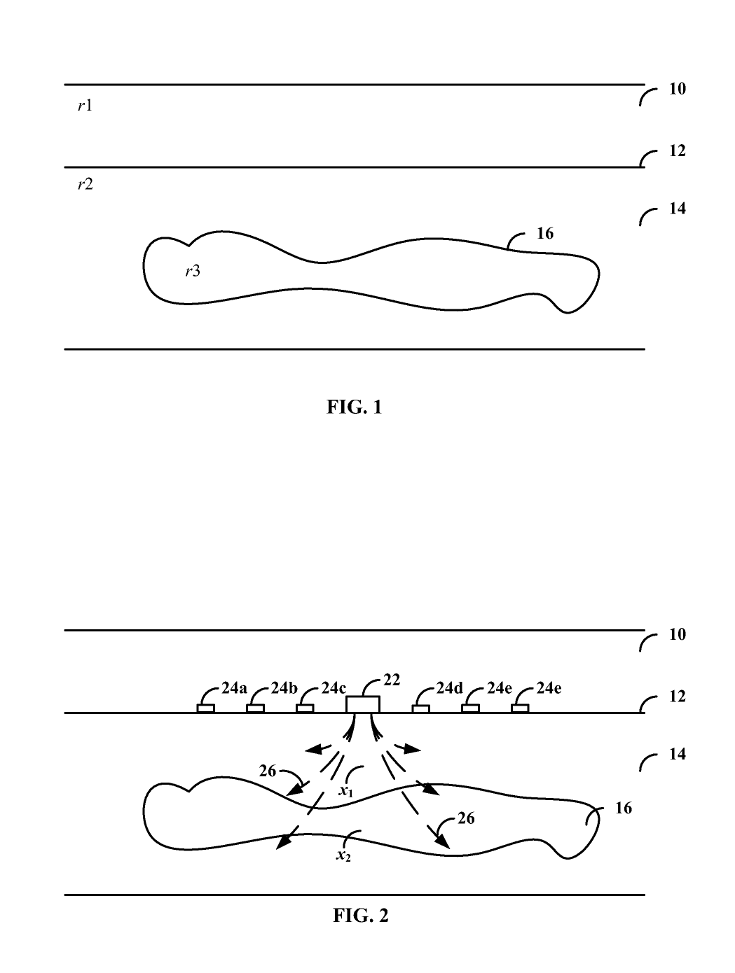

### DETAILED DESCRIPTION

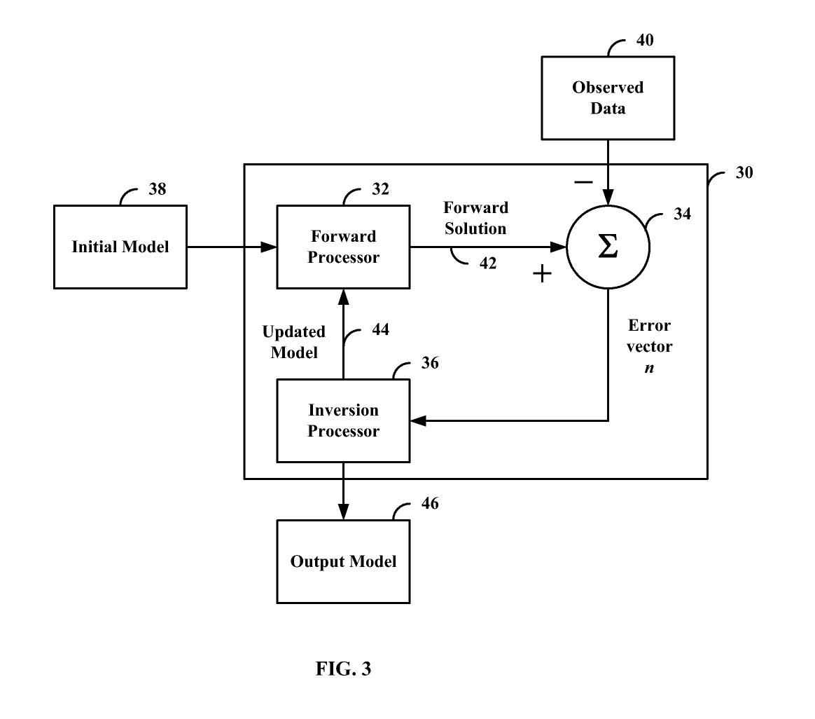

Referring now to FIG. 3, an exemplary 3-D inversion processing system in accordance with this invention is described. Inversion processing system 30 includes forward processor 32, error processor 34 and inversion processor 36. Inversion processing system 30 may be implemented in hardware, software, or a combination of hardware and software. Inversion processing system 30 receives initial model parameters 38 and observed data 40, and generates a 3-D output model 46 that fits the observed data. Initial model parameters 38 may be user-supplied estimates of model parameters based on various factors, such as the source and receiver geometries used to obtain observed data 40, the measured frequencies, subsurface conductivity estimates, and other similar factors.

Observed data 40 includes EM data obtained from measurements at or near the Earth's surface, and may include MT data (such as mMT data) and/or CSEM data (such as mCSEM data). In particular, 3-D MT data may be obtained from measurements at the Earth's surface or seafloor of naturally occurring electric and magnetic fields. A standard 3-D MT dataset typically comprises four complex quantities (impedances) as a function of receiver position and frequency. Each of these quantities is a component of a 2×2 impedance tensor that relates the horizontal electric fields to the horizontal magnetic fields at a specific location and frequency. If the vertical magnetic field is also recorded, then a similar two-component vertical magnetic transfer function can be derived that relates the vertical magnetic field to the horizontal magnetic fields.

Three-dimensional CSEM data may be obtained from measurements at the Earth's surface or in the sea of electric and magnetic fields due to a time-harmonic electric or magnetic dipole source field. Typically, data are electric and magnetic fields collected as a function of frequency and offset between source and receiver. Both transmitters and receivers may have arbitrary orientations, and the sources may be electric and/or magnetic, horizontal and/or vertical, and may have arbitrary frequency spectrums.

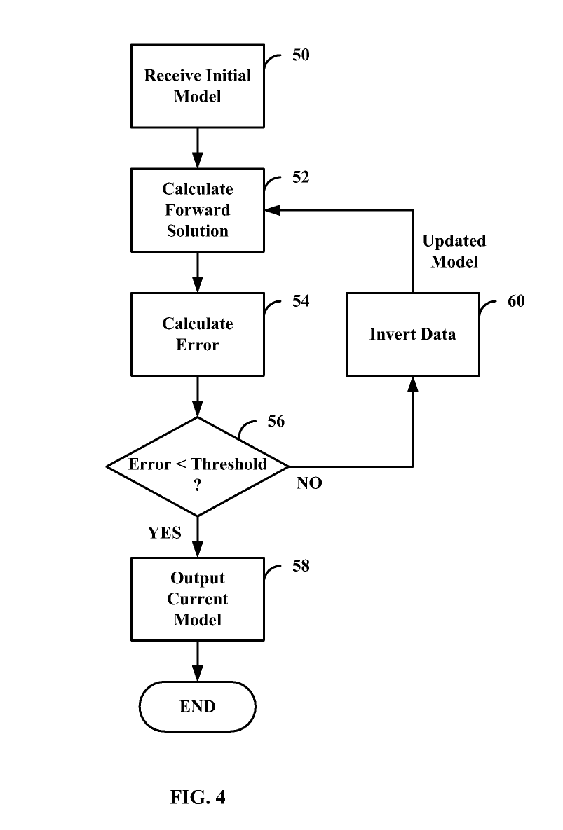

Referring now to FIGS. 3 and 4, an exemplary process implemented by inversion processing system 30 is described. Beginning at step 50, initial model parameters 38 are received. As described above, initial model parameters 38 may be user-supplied estimates of model parameters. Next, at step 52, forward processor 32 calculates a forward solution 42 based on initial model parameters 38. At step 54, error calculation processor 34 calculates the difference between observed data 40 and forward solution 42, and generates error vector n. At step 56, inversion processor 36 determines if error vector n is less than a predetermined threshold T (e.g., threshold T may be set to a normalized RMS error of 1). If so, then at step 58 inversion processor 36 outputs the current model parameters as the final model parameters, and the process terminates. Persons of ordinary skill in the art will understand that as part of the output process, the final model parameters may be stored in computer readable media, such as a magnetic media, optical media, flash memory, random access memory, or other similar computer-readable media. In addition, persons of ordinary skill in the art will understand that the final model may be used for geophysical exploration.

If, however, error vector n is greater than or equal to the predetermined threshold T, then at step 60, inversion processor 36 performs 3-D inversion to generate updated model parameters 44. The process then returns to step 52, and forward processor 32 calculates a forward solution 42 based on updated model parameters 44. This process repeats in an iterative fashion until error vector n is less than the predetermined threshold (or until a predetermined number of iterations have been performed).

In each iteration, forward calculation processor 32 calculates forward solution 42 by numerically solving Maxwell's equations. In particular, for marine applications, forward calculation processor 32 numerically solves Maxwell's equations in the solid Earth, ocean and atmosphere using (1) horizontal current sources in the atmosphere to represent ionospheric and magnetospheric sources for MT sources, and (2) a compact finite volume source in the marine layer for mCSEM to represent the electric or magnetic dipole sources.

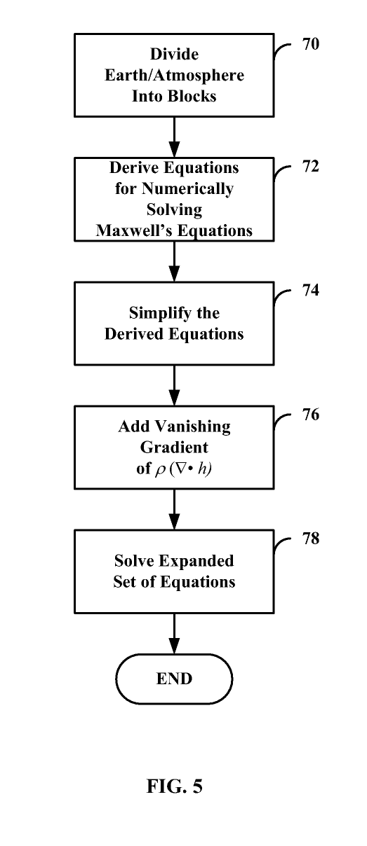

Referring now to FIG. 5, an exemplary forward calculation process is described, specifically with respect to marine applications. Beginning at step 70, forward calculation processor 32 divides a model of the earth and atmosphere into rectangular blocks, with magnetic fields h defined along the block edges and electric fields e defined along the normals to the block faces. Persons of ordinary skill in the art will understand that the blocks alternatively may be tetrahedral blocks, or other polygonal blocks. Next, at step 72, finite difference equations are derived for approximating Maxwell's equations using this formulation. The derived equations include electric and magnetic field components. Persons of ordinary skill in the art will understand that this step alternatively may be implemented using finite element techniques, integral equation methods, or other similar techniques for numerically solving Maxwell's equations.

Next, at step 74, the equations derived in step 72 are simplified by eliminating either the electric fields or the magnetic fields from the equations. In particular, a second-order set of equations in h may be obtained by eliminating the electric fields from the difference equations. Alternatively, a second-order set of equations in e may be obtained by eliminating the magnetic fields from the difference equations.

In either case, the presence of low conductivity air layers or low frequencies leads to a near indeterminacy in Maxwell's equations because the equations are no longer “coupled” to each other (i.e., if the conductivity is zero, then in Ampere's law, the curl of the magnetic field is no longer “coupled” to the electric field, because the curl of the magnetic field is zero). As a result, additional information is needed to solve the system of equations. To accomplish this goal, at step 76, a vanishing gradient of ρ(∇·h) is added to the set of simplified equations from step 74 to develop an expanded set of equations. This step removes the near indeterminacy of Maxwell's equations when the conductivity or frequency go to zero, and has the effect of stabilizing and diagonalizing the system of equations. Next, at step 78, the expanded set of equations are solved using linear conjugate gradient methods, or other similar methods.

Referring again to FIG. 3, after forward processor 32 calculates forward solution 42 error calculation processor 34 calculates the difference between observed data 40 and forward solution 42, and generates error vector n. If error vector n is greater than or equal to the predetermined threshold T, inversion processor 36 performs 3-D inversion to generate updated model parameters 44. Inversion processor 36 may perform 3-D inversion of MT data, CSEM data, or may perform 3-D joint inversion of MT and CSEM data. An exemplary 3-D inversion process in accordance with this invention will now be described.

A general MT/CSEM inverse problem in canonical form may be described as follows:

d=F(m)+n (1)

where d is a data vector, m is a model vector, n is an error (or noise) vector, and F is a forward modeling function. Data vector d may be described as d=[d¹ d² . . . d^{N}]^{T}, with each dⁱ being a component of the MT impedance tensor, vertical magnetic transfer function, and/or the CSEM electric field or magnetic field, or any other such combination of electric and magnetic fields. Although the underlying physical properties we are modeling are the electrical resistivity (or its inverse, the electrical conductivity), it is often advantageous to parameterize our model as some other function of electrical resistivity, such as the logarithm of resistivity. Therefore, we define model vector m as m=[m¹ m² . . . m^{M}]^{T}, which is a vector of parameters that defines a general function of the electrical conductivity in the subsurface.

For equation (1), the Earth is assumed to have isotropic or anisotropic conductivity. Then, being consistent with the numerical forward modeling scheme described above, M is defined as the number of model blocks in a 3-D grid, and each mⁱ is defined as some function of electrical resistivity (isotropic or anisotropic) for a unique block. Persons of ordinary skill in the art will understand that model vector m may define the electrical resistivity, conductivity, the logarithm of either resistivity or conductivity, or some other function, such as a nonlinear transformation that is defined to enforce bounds on the model (e.g., m must be greater than m1 and less than m2).

In accordance with this invention, the 3-D MT/CSEM inverse problem is solved based on the framework of Tikhonov regularization. Such models minimize an objective function, ψ(m), defined by:

ψ(m)=(d−F(m))^{T}V⁻ⁱ(d−F(m))+λm^{T}L^{T}Lm (2)

for given λ, V and L. The “regularization parameter,” λ, is a positive number and can be either a constant or variable. The positive-definite matrix V plays the role of a variance-covariance matrix of the error vector n. The second term of ψ(m) defines a “stabilizing functional” on the model space.

In accordance with this invention, the matrix L may be chosen to represent a smoothing operator, or to encourage more “blocky” types of models. For smooth models, L is a finite difference approximation to the gradients or Laplacian of the model. For blocky models, L may be an approximation to various types of model norms. For example, for an Lp norm:

L(x)=(x²+α²)m/2 (3)

Persons of ordinary skill in the art will understand that other similar norms may be used, and that the regularization may be applied to the differences between a model and an a priori model (e.g., (m-m0)). Further, “tears” may be introduced into L, to eliminate the smoothing constraint across any cell boundary in the model, and thus allow sharp discontinuities in the model.

In the case of anisotropy, the following additional regularization term may be added to equation (2):

λ_{α}m^{T}Hm (4)

where πₐ is the anisotropy regularization parameter, which may be constant or variable, and H is a matrix that defines a constraint (for the example of diagonal anisotropy, or transverse anisotropy) between the diagonal components of resistivity (i.e., ρxx, ρyy and ρzz), and can be for example set to the gradient between the different models. Persons of ordinary skill in the art will understand, however, that many alternative representations may be used, so this is not meant to be exhaustive.

In addition, damping may be added to the inversion to bias the solution to the m0 a priori model by adding the following damping term to equation (2):

Ψ_{α}9m−m0)^{τ}M(m−m0) (5)

where M is a diagonal matrix with weights on the diagonal. This damping term may be used to help damp out unwanted artifacts from the inversion. Additionally, if the true resistivity at certain parts of the model is known, this damping term may be used to keep the resistivity fixed at the known value. Persons of ordinary skill in the art will understand that this list is not exhaustive, and many other types of constraints may be added.

In an exemplary embodiment of this invention, nonlinear conjugate gradient (“NLCG”) methods are used to minimize the objective function ψ(m) in equation (2). NLCG is a well-known optimization method that has been applied in a variety of nonlinear geophysical inverse problems. Although NLCG is a general optimization method, it is not necessarily efficient for use with computationally intensive problems like two-dimensional and 3-D MT/CSEM inversion. Methods in accordance with this invention cater to and exploit the structure of the MT and CSEM forward problems. Persons of ordinary skill in the art will understand that the objective function ψ(m) may be minimized using methods other than NLCG, such as Gauss Newton and other similar methods.

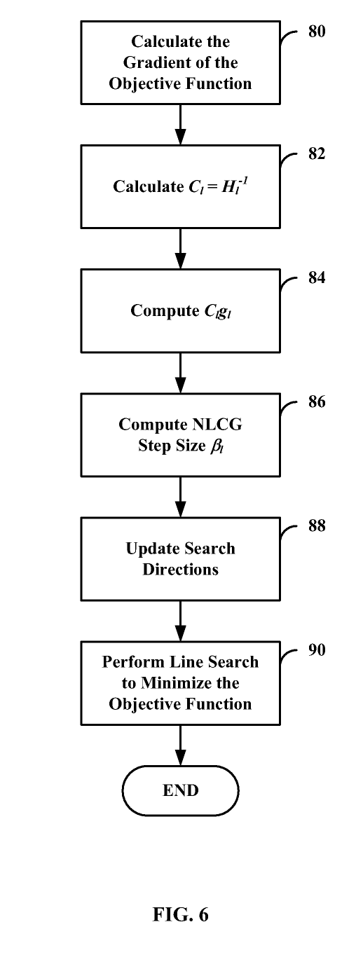

Referring now to FIG. 6, an exemplary NLCG method in accordance with this invention is described for minimizing the objective function Ψ(m). Beginning at step 80, the gradient of the objective function Ψ(yx), referred to herein as g, is calculated. This involves one additional full forward problem with pseudo-sources to compute the results of the sensitivity matrix times arbitrary vectors. That is, computing the gradient of the objective function requires the result of the sensitivity matrix (or Jacobian) times the data residuals V⁻¹(d−F(m)). Persons of ordinary skill in the art will understand that this is equivalent to the sum of appropriately weighted point source solutions to Maxwell's equations, and also is equivalent to one solution with all appropriately weighted point sources applied simultaneously.

The data part of the gradient g may be solved using the following exemplary technique. First, using a finite difference approximation to Maxwell's equations, the forward modeling problem may be written as:

Kv=s (6)

Where v is a vector of unknown magnetic (or electric) fields, K is a coefficient matrix that depends on resistivity and frequency, and s contains the effects of the source terms and boundary values. The gradient of the objective function is:

g(m)=−2A^{T}V⁻¹(d−F(m))+2λL^{τ}m (7)

where A is defined as the Frechet derivatives or Jacobian or Sensitivity matrix, and defines the sensitivity of the data to small changes in the model.

The observed data are some combination of electric and/or magnetic fields. In the case of electric fields, for example (and the results for magnetic fields follows the same formulation), the electric fields predicted by a model are F=α^{τ}v, where α is a given vector that computes the electric field from the computed magnetic field values (this is just application of Maxwell's equations and the model geometry, and is a known vector).

The Jacobian then involves terms like:

$$\frac{\partial \text{?}}{\partial ρ} = \frac{\partial ( {α}^{T} v )}{\partial \text{?}} = {( \frac{\partial \text{?}}{\partial ρ} )}^{T} v + {a}^{T} {K}^{- 1} [ \frac{\partial s}{\partial ρ} - \frac{\partial K}{\partial ρ} v ] \\ \text{?} \text{indicates text missing or illegible when filed} \qquad ( 8 )$$

Thus, computing one sensitivity term is equivalent to one forward problem with the source:

$$[ \frac{\partial s}{\partial ρ} - \frac{\partial K}{\partial ρ} v ] \qquad ( 9 )$$

which is in the model volume. For A^{T} problems, we instead solve v=K⁻¹α (which are sources at the surface), and then we substitute this in equation 8 above.

Putting all sources in at once, and doing one forward problem is then the equivalent of solving A^{T} times a vector or solving A times a vector, using the formulas of equations 6, 8 and 9.

Next, at step 82, a preconditioner operator C is calculated. The efficiency of NLCG for computing solutions of the inverse problem depends strongly on the preconditioner and the line minimization algorithm. The purpose of preconditioner operator C₁ is to steer the gradient g: into a direction in model space which parallels the final solution as much as possible. A restriction on this goal is that applying the preconditioner operator can require an excessive amount of computation if it is too complicated. To overcome this problem, methods and apparatus in accordance with this invention use a preconditioner operator C₁=H₁⁻², where H₁ is an approximation of the Hessian of the objective function Ψ(m), and is defined as:

H₁=(Ā₁^{T}V⁻²Ā₁+λL^{T}L) (10)

where Ā₋₁^{T}V⁻¹Ā₁ is the diagonal component of an approximate data Hessian computed using one-dimensional adjoint fields and true 3-D forward fields, and λL^{T}L is a model Hessian. In this regard, the preconditioner operator C₁ approximates the inverse of the Hessian of the objective function ψ(m).

The preconditioner C₁ can be generalized to include more entries than just the diagonal part, and it can be generalized to compute the true 3D Hessian if one can compute the 3D adjoint fields (which is possible even now for small models but requires the inverse of the coefficient matrix multiplying a vector, something that for large 3D models can only be done on clusters using parallel programming). In the case of anisotropy, the preconditioner C₁ is expanded to include also the λ₂m^{T}Hm term.

To further simplify the calculations, preconditioner operator C₁ need not be calculated for every value of 1. For example, preconditioner C₁ may be computed for every third iteration 1, until convergence is reached, or until the program terminates. Thus, the value C₀ may be calculated and used as the preconditioner value for C₀, C₁ and C₂, the value C₂ may be calculated and used as the preconditioner value for C₃, C₄ and C₅, and so on. Persons of ordinary skill in the art will understand that the interval between successive preconditioner calculations may be more or less than three.

Next, at step 84, the preconditioner C₁ is multiplied by β₁. The computational requirements needed to solve the system is less than one forward function evaluation and thus adds little overhead to the algorithm. Next, at step 86, an NLCG step size β₁ is computed as follows:

$$\text{?} = \frac{g \text{?} C \text{?} ( g \text{?} - g \text{?} )}{g {\text{?}}_{- 1} C {\text{?}}_{- 1} g \text{?}} \text{?} = 0 , 1 , 2 , … \\ \text{?} \text{indicates text missing or illegible when filed} \qquad ( 11 )$$

where g₁ denotes the gradient of ψ(m) at m=ma, C₁ is the preconditioning operator, and β₂ enforces conjugacy of the search directions.

NLCG defines a model sequence in terms of line minimizations along search directions. Similar to linear conjugate gradient algorithms, the model sequence is defined by:

mᵢ₋₁=m₁+α₂ρ₂ 1=0,1,2 . . . (12)

with mₒ given, where α₁ is a model sequence step size (defined below), and ρ₁ are the search directions. At step 88, the search directions ρ₁ are updated using the NLCG step size β₂ computed in step 86. In particular, the search directions are updated as:

ρ_{o=C}ₒgₒ (13 )

ρ₁=C₁g₂+β₂ρₗ₋₁ 1=1,2,. . .

Next, at step 90, a line search is performed to minimize the objective function ψ(m) along the search directions ρ₁. That is, for each 1, the model sequence step-size α₁ is calculated to minimize the objective function ψ(m) along the search directions ρ₁. Although this line search is a one dimensional problem, with the scalar α₁ as the unknown, each tested value of α₁ requires the computation of at least one forward problem, which in three dimensions is computationally demanding. Thus, it is very important to use an algorithm that does a reasonable job of minimizing the objective function ψ(m) in the current search direction with as few trials as possible.

In accordance with this invention, a line minimization algorithm is used that is basically a univariate version of the Gauss-Newton method. The important result of this algorithm is that each step of the line minimization iteration requires the equivalent work of only three forward calculations (the real one and two pseudo ones). An additional efficiency is the choice of stopping criterion. It ensures that when the forward problem is well-approximated by its linear approximation, each line minimization converges in a single step.

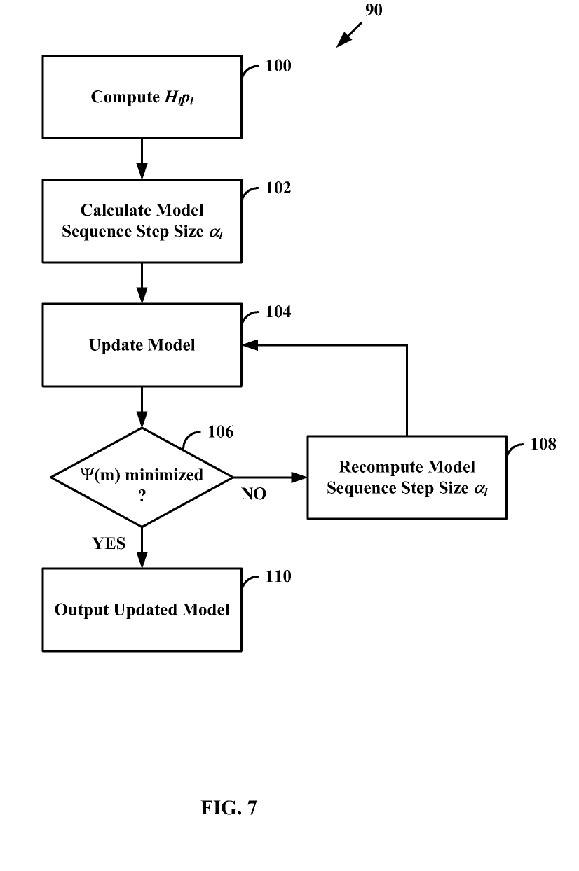

Referring now to FIG. 7, an exemplary line search process 90 in accordance with this invention is described. Beginning at a step 100, the value of the Hessian H (from equation 3) times the search direction ρ₁ is calculated. This requires solving another full forward problem. Next, at step 102, the model sequence step size α₁ is calculated. In particular, α₁ may be calculated using linear approximation as:

$${α}_{1} = \frac{\text{?}}{p \text{?} {Hp}_{1}} \\ \text{?} \text{indicates text missing or illegible when filed} \qquad ( 14 )$$

Next, at step 104, the model is updated as follows:

mₗ₋₁=mₗ+αₗρₗ, l=0,1, . . . (15)

Next, at step 106, a determination is made whether the objective function ψ(M) has been minimized. If not, at step 108, the step size α₁ is recomputed using bisection or other similar method, and the process returns to step 104 to update the model. If, however, the objective function ψ(m) has been minimized, then at step 110, the current model is output as updated model 44 that is provided to forward calculation processor 32.

Apparatus and methods in accordance with this invention may be implemented as a computer-implemented method, system, and computer program product. In particular, this invention may be implemented within a network environment (e.g., the Internet, a wide area network (“WAN”), a local area network (“LAN”), a virtual private network (“VPN”), etc.), or on a stand-alone computer system. In the case of the former, communication throughout the network can occur via any combination of various types of communications links. For example, the communication links may comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

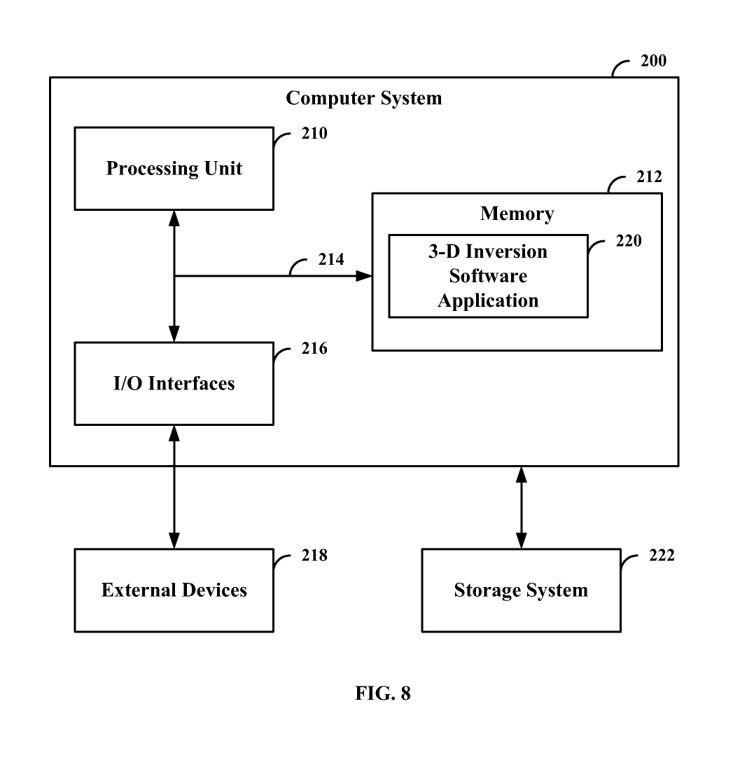

For example, as shown in FIG. 8, the present invention may be implemented on a computer system, such as computer system 200 that includes a processing unit 210, a memory 212, a bus 214, input/output (“I/O”) interfaces 216 and external devices 218. Processing unit 210 may be a computer or processing unit of any type that is capable of performing the functions described herein. Memory 212 is capable of storing a set of machine readable instructions (i.e., computer software) executable by processing unit 210 to perform the desired functions. Memory 212 is any type of computer-readable media or device for storing information in a digital format on a permanent or temporary basis, such as, e.g., a magnetic media, optical media, flash memory, random access memory, or other similar memory.

In particular, memory 212 includes a 3-D inversion software application 220, which is a software program that provides the functions of the present invention. Alternatively, 3-D inversion software application 220 may be stored on storage system 222. Processing unit 210 executes the 3-D inversion software application 220. While executing computer program code 220, processing unit 210 can read and/or write data to/from memory 212, storage system 222 and/or I/O interfaces 216. Bus 214 provides a communication link between each of the components in computer system 200. External devices 218 can comprise any devices (e.g., keyboard, pointing device, display, etc.) that enable a user to interact with computer system 200 and/or any devices (e.g., network card, modem, etc.) that enable computer system 200 to communicate with one or more other computing devices.

Computer system 200 may include two or more computing devices (e.g., a server cluster) that communicate over a network to perform the various process steps of the invention. Embodiments of computer system 200 can comprise any specific purpose computing article of manufacture comprising hardware and/or computer program code for performing specific functions, any computing article of manufacture that comprises a combination of specific purpose and general purpose hardware and/or software, or the like. In each case, the program code and hardware can be created using standard programming and engineering techniques, respectively.

Moreover, processing unit 210 can comprise a single processing unit, or can be distributed across one or more processing units in one or more locations, e.g., on a client and server. Similarly, memory 212 and/or storage system 222 can comprise any combination of various types of data storage and/or transmission media that reside at one or more physical locations. Further, I/O interfaces 216 can comprise any system for exchanging information with one or more external devices 218. In addition, one or more additional components (e.g., system software, math co-processing unit, etc.) not shown in FIG. 8 can be included in computer system 200.

Storage system 222 may include one or more storage devices, such as a magnetic disk drive or an optical disk drive. Alternatively, storage system 222 may include data distributed across, for example, a LAN, WAN or a storage area network (“SAN”) (not shown). Although not shown in FIG. 8, additional components, such as cache memory, communication systems, system software, etc., may be incorporated into computer system 200.

The foregoing merely illustrates the principles of this invention, and various modifications can be made by persons of ordinary skill in the art without departing from the scope and spirit of this invention.

1. A method for performing three-dimensional inversion of geophysical data, the method comprising:
(a) receiving initial model parameters;
(b) calculating a forward solution based on the initial model parameters;
(c) calculating an error vector based on a difference between the forward solution and observed electromagnetic data;
(d) if the calculated error vector is greater than or equal to a predetermined threshold, performing an inversion to generate updated model parameters;
(e) repeating steps (b)-(d) using the updated model parameters until the calculated error vector is less than the predetermined threshold; and
(f) outputting the updated model parameters as final model parameters.

2. The method of claim 1, wherein the observed electromagnetic data comprise magnetotelluric data.

3. The method of claim 1, wherein the observed electromagnetic data comprise controlled-source electromagnetic data.

4. The method of claim 1, wherein the observed electromagnetic data comprise magnetotelluric data and controlled-source electromagnetic data.

5. The method of claim 1, wherein calculating the forward solution comprises numerically solving the forward solution for a region of model space at which conductivity or frequency approach zero.

6. The method of claim 5, wherein calculating the forward solution comprises:
using finite difference equations to numerically solve Maxwell's equations; and
using a vanishing gradient of conductivity times a divergence of a magnetic field.

7. The method of claim 1, wherein performing a three-dimensional inversion comprises performing a nonlinear conjugate gradient method to minimize an objective function of model space.

8. The method of claim 7, wherein performing a nonlinear conjugate gradient method comprises calculating a preconditioner that approximates an inverse of a Hessian of the objective function.

9. The method of claim 8, wherein calculating a preconditioner comprises calculating a diagonal of an approximate data Hessian.

10. The method of claim 7, wherein performing a three-dimensional inversion comprises efficiently performing a line search to minimize the objective function.

11. Apparatus for performing three-dimensional inversion of geophysical data, the apparatus comprising:
(a) means for receiving initial model parameters;
(b) means for calculating a forward solution based on the initial model parameters;
(c) means for calculating an error vector based on a difference between the forward solution and observed electromagnetic data;
(d) means for determining if the calculated error vector is greater than or equal to a predetermined threshold;
(e) means for performing a three-dimensional inversion to generate updated model parameters;
(f) means for repeating steps (b)-(e) using the updated model parameters until the calculated error vector is less than the predetermined threshold; and
(g) means for outputting the updated model parameters as final model parameters.

12. The apparatus of claim 11, wherein the observed electromagnetic data comprise magnetotelluric data.

13. The apparatus of claim 11, wherein the observed electromagnetic data comprise controlled-source electromagnetic data.

14. The apparatus of claim 11, wherein the observed electromagnetic data comprise magnetotelluric data and controlled-source electromagnetic data.

15. The apparatus of claim 11, wherein the means for calculating the forward solution comprises means for numerically solving the forward solution for a region of model space at which conductivity or frequency approach zero.

16. The apparatus of claim 15, wherein the means for calculating the forward solution comprises:
means for using finite difference equations to numerically solve Maxwell's equations; and
means for using a vanishing gradient of conductivity times a divergence of a magnetic field.

17. The apparatus of claim 11, wherein the means for performing a three-dimensional inversion comprises a means for performing a nonlinear conjugate gradient method to minimize an objective function of model space.

18. The apparatus of claim 17, wherein the means for performing a nonlinear conjugate gradient method comprises a means for calculating a preconditioner that approximates an inverse of a Hessian of the objective function.

19. The apparatus of claim 18, wherein the means for calculating a preconditioner comprises a means for calculating a diagonal of an approximate data Hessian.

20. The apparatus of claim 17, wherein the means for performing a three-dimensional inversion comprises a means for efficiently performing a line search to minimize the objective function.
